(19) United States
(12) Patent Application Publication
(10) Pub. No.: US 2004/0218248 A1
(43) Pub. Date: Nov. 4, 2004

(54) Device for spatial modulation of a light beam and corresponding applications

(75) Inventors: Jean-Louis De Bougrenet De La Tocnaye, Guilers (FR); Michel Barge, Milizac (FR); Raymond Chevalier, Plougonvelin (FR); Laurent Dupont, Plouzane (FR); Tatiana Loukina, Brest (FR)

Correspondence Address: MERCHANT & GOULD PC, P.O. BOX 2903, MINNEAPOLIS, MN, 55402-0903, US

(73) Assignee: OPTOGONE, Plouzane (FR)

(21) Appl. No.: 10/776,849

(22) Filed: Feb. 11, 2004

(30) Foreign Application Priority Data
Feb. 12, 2003 (FR) FR 03 01699

(51) Int. Cl. G02F 1/153

(52) U.S. Cl. 359/267

(57) ABSTRACT

This invention relates to a device for spatial modulation of a light beam, comprising a Polymer Dispersed Liquid Crystal (PDLC) element, the said element comprising at least two areas that can be addressed independently of each other using a system with at least two electrodes.

According to the invention, the said electrodes have a predetermined non-linear pattern chosen so as to reduce the sensitivity of the said device to polarisation, due to the appearance of at least one transverse electrical field between the said at least two electrodes, and the said device also comprises optical means of reducing the sensitivity to polarisation comprising at least one anisotropic phase delay plate.

The domain of this invention is optical telecommunications. More precisely, the invention relates to a liquid crystal device for spatial modulation of light that is insensitive to polarisation of the incident light beam.

Devices of this type, usually called light modulators, are key components of existing telecommunication systems. They can be used to perform functions such as dynamic attenuation or spatial phase shift of the light beam, for spectrum equalisation purposes, or for beam shaping, or to obtain variable delay lines or tuneable filters.

Several types of modulators capable of performing these various functions are already known, but among these modulators, this invention is particularly applicable to light modulators comprising a liquid crystal element used to attenuate or shift the phase of all or part of the light beam.

Some of these modulators use a voltage controlled liquid crystal cell, such that the voltage applied to the terminals of the cell varies the phase of the light that passes through it by rotation of the optical axis of the crystal, from a direction parallel to the direction of propagation of light towards a direction perpendicular to it, or vice versa. For example, this type of effect is used in the optical attenuator presented in international patent application No. WO 02/071133 A2 in the name of XTELLUS Inc.

New types of modulators have recently been developed, in which the liquid crystal element has been replaced by a cell containing a liquid crystal and polymer mix called Polymer Dispersed Liquid Crystal (PDLC).

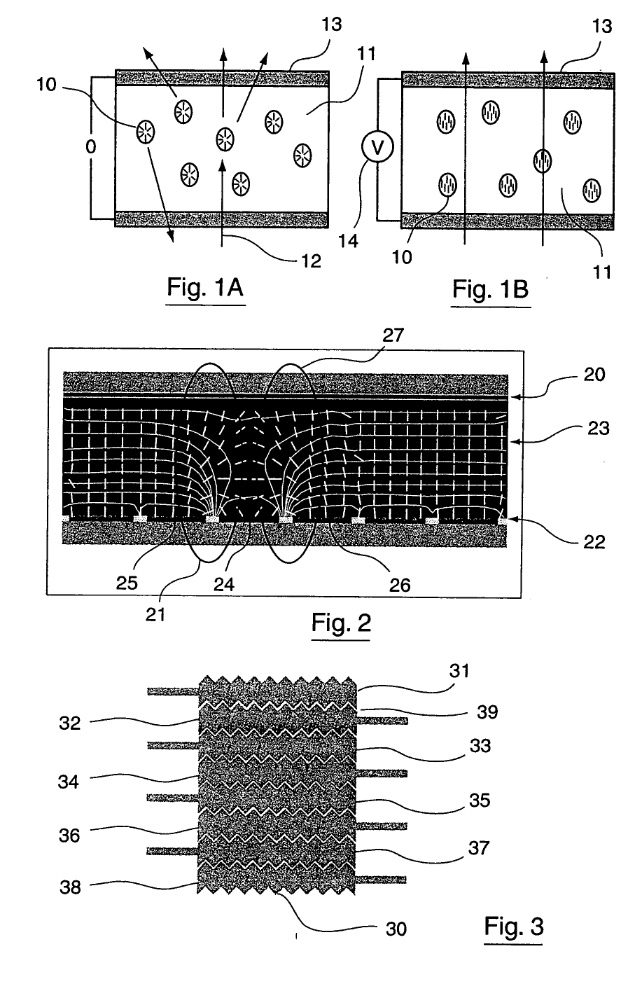

The operating principle of this type of PDLC cell is described below with reference to FIGS. 1a and 1b. Liquid crystal droplets 10 are formed within a host polymer material 11. The orientation of these droplets within the polymer is arbitrary when at rest (FIG. 1a), in other words when there is no electrical field applied to the terminals of the cell. Due to the difference in the optical index between the extraordinary index of the liquid crystal and of the polymer, light 12 that passes through the cell 13 passes through a large number of diffusers, or if the droplets are small compared with the wave length of light (typically from 10 to 100 mm, the term nano-PDLC is used), a large number of delay gates as illustrated by the arrows in FIG. 1a.

When a voltage 14 is applied to the terminals of the cell (FIG. 1b), the liquid crystal droplets 10 are aligned in the electrical field thus created. Only the ordinary index of the liquid crystal is then visible by light 12; since this index is comparable to the index of polymer, the medium becomes transparent as illustrated by the arrows in FIG. 1b.

Therefore the attenuation or phase shift effects of a light beam obtained using a PDLC cell of this type use very different properties from the properties used in a conventional liquid crystal cell. The properties used in a PDLC cell are light diffusion or delay properties caused by the presence of liquid crystal droplets, and not properties related to rotation of the optical axis of the crystal as is the case for conventional liquid crystal cells.

The voltage control of a PDLC cell is usually applied using a system of electrodes, organised in the form of modules or matrices that independently address some areas of the cell, or pixels.

In the usual configuration of a spatial light modulator, in other words when the electrical field applied to the PDLC material is collinear with the optical wave vector, this type of device may be considered as being almost insensitive to polarisation if the number, shape and size of the elementary diffusers (in other words liquid crystal droplets) are chosen correctly.

This property of insensitivity to the polarisation of incident light becomes very important in the telecommunications domain, for which a low polarisation dispersion loss (PDL) is usually required.

If the PDLC cell is divided into several elementary areas or pixels that can be addressed independently by an appropriate system of electrodes, this property of insensitivity to polarisation is usually satisfied in the central region of each elementary pixel, but not in the inter-pixel regions.

The relative potential difference between two addressed adjacent pixels generates transverse electrical fields that have the effect of giving a preferential orientation to the liquid crystal droplets perpendicular to the optical wave vector.

Obviously, this phenomenon depends on the relative voltages between the different pixels in the cell, and its expression is minimum when all elementary areas of the PDLC cell have the same voltage.

If elementary areas of the cell cannot be closed off (which for example is the case when the modulator is used for continuous attenuation of the optical signal, the light signal then illuminating the entire modulator rather than each pixel individually), the effect of this phenomenon is to reintroduce a macroscopic optical anisotropy which causes an increase in the global PDL and makes the modulator incompatible with constraints in modern optical telecommunication systems.

This phenomenon of sensitivity to the polarisation of incident light can also arise in the useful region of a pixel, when the pixel is smaller than the region between the pixels. In this configuration, effects of the electrical field created on a pixel are sensitive to the adjacent pixel, or even beyond the inter-pixel area.

This unwanted phenomenon caused by the creation of transverse electrical fields is shown in more detail with reference to FIG. 2.

A spatial modulator of light is considered composed of two glass plates, one covered with a counter electrode 20, and the other covered with a network of transparent electrodes 22, between which a PDLC type material 23 is inserted. Each electrode applies a local addressing voltage to the material, and an electrical field collinear with the light beam wave vector is then created illuminating the modulator. Each electrode in the network is increased to a specific potential, consequently relative voltage variations between the electrodes (for example electrodes references 24, 25 and 26) are induced and transverse voltages appear, illustrated in FIG. 2 by field lines of areas 21 and 27.

It may be difficult to reduce these transverse voltages due to the variable modulation on electrodes and the high threshold voltages of the liquid crystal. However, they depend on the amplitude of the transverse electrical field in the inter-electrode area and contribute to introducing preferential orientations of liquid crystal droplets, which induces a birefringence of the PDLC material.

The inventors of this patent application have observed that in most cases, considering values of addressing voltages of the different areas of the liquid crystal element and the small dimensions of regions between pixels, these induced transverse voltages are sufficient to create an average preferential orientation perpendicular to the network of electrodes.

In particular, another purpose of the invention is to provide a technique for spatial modulation of light to compensate for this phenomenon, and therefore to make the implementation of this technique independent of the polarisation of incident light.

The problem of dependence on polarisation of optical liquid crystal devices has been considered, for example in the international patent application No. WO 02/071133 A2 in the name of XTELLUS Inc. mentioned above. However, the phenomenon of dependence on polarisation appearing in this type of device is very different from the phenomenon that this invention is intended to solve, due to the difference in the nature of the materials used (conventional liquid crystal or PDLC) as described above. Remember that the property used in a conventional liquid crystal cell is a rotation property of the optical axis of the liquid crystal (modulation of the birefringence axis). On the other hand, in a PDLC cell, the droplets form light beam diffusers or delay gates.

Furthermore, solutions envisaged particularly in the XTELLUS Inc. document consist of inserting a quarter-wave plate or half-wave plate in the device, depending on whether the device is in a reflection or transmission configuration.

This solution cannot satisfactorily solve the problem of dependence on polarisation that occurs in PDLC based spatial modulators, to which this invention is particularly applicable.

Therefore, the purpose of the invention is to provide a technique for spatial modulation of light based on a liquid crystal cell of the PDLC type controlled by a system of electrodes that minimises the impact of the appearance of transverse electrical fields between the electrodes.

More precisely, one purpose of the invention is to provide such a technique that is simple and inexpensive to implement.

Another purpose of the invention is to implement such a technique that can easily be adapted as a function of the envisaged application type.

Another purpose of the invention is to supply such a technique that enables design of compact spatial modulators satisfying the reliability requirements of the optical telecommunications field.

These purposes, and others that will appear later, are achieved using a device for spatial modulation of a light beam, comprising a Polymer Dispersed Liquid Crystal (PDLC) element, the said element comprising at least two areas that can be addressed independently of each other using a system with at least two electrodes.

According to the invention, the said electrodes have a predetermined non-linear pattern chosen so as to reduce the sensitivity of the said device to polarisation, due to the appearance of at least one electrical field between the said at least two electrodes and the said device also comprises optical means of reducing the sensitivity to polarisation comprising at least one anisotropic phase delay plate.

Thus the invention is based on a completely new and inventive approach to spatial modulation of light based on a PDLC cell. Techniques to reduce the sensitivity to polarisation envisaged in the past for conventional modulators with a liquid crystal cell, usually consisted of combining the modulator with one or several appropriate optical elements of the quarter-wave plate or birefringent prism type. On the other hand, with this approach described herein, such a modulation device is made insensitive to polarisation by acting directly on the pattern of cell electrodes.

Thus, the invention consists of breaking the regular arrangement of the electrode (usually a straight line) so as to avoid a preferential alignment of inter-electrode electrical fields, which is conducive to a direction of alignment of the liquid crystal droplets at the edges of the areas (or pixels) of the modulator, and therefore contribute to increasing the PDL of the device.

In particular, electrode patterns with zero average are preferred so as to statistically minimise the various transverse electrical fields created, and thus to reduce the harmful preferential alignment of liquid crystal droplets.

To further increase the insensitivity of the device to polarisation, this particular pattern of electrodes is coupled to the use of a phase delay plate of the quarter-wave or half-wave plate type. The combined use of a phase delay plate and a non-linear electrode pattern thus guarantees effective independence of the device according to the invention to polarisation.

Preferably, the said predetermined pattern has a zero average.

The result is then a statistical cancellation of transverse fields that produce a preferential orientation of liquid crystal droplets.

Advantageously, the said liquid crystal is of the nano-PDLC type, droplets of the said liquid crystal dispersed in the said polymer having a diameter of between approximately 10 and 100 nm.

According to a first advantageous variant of the invention, the said predetermined electrode pattern is sinusoidal.

According to a second advantageous variant of the invention, the said predetermined electrode pattern is a saw tooth pattern.

According to a first preferred embodiment, the said device has a reflection configuration and the said phase delay plate is a quarter-wave plate.

Advantageously, the said system has at least two electrodes also comprising at least one counter electrode, the said quarter-wave plate is oriented at approximately 45° from the direction of the said electrodes, and it is inserted between the said counter electrode and a mirror.

According to a second preferred embodiment, the device has a configuration in transmission and the said phase delay plate is a half-wave plate.

Advantageously, in this second embodiment of the invention, the said half-wave plate is inserted between two adjacent liquid crystal elements.

These various characteristics of the device according to the invention may also be combined with the use of a polarisation diversity device, according to the various configurations described below.

According to a first advantageous configuration of the device according to the invention, the said device has a configuration in transmission and comprises:

two linear birefringent prisms, mounted top to bottom,

a first half-wave plate oriented at approximately 45° from the direction of the said electrodes,

a second half-wave plate located on an optical path of a refracted order of the said beam at the output of one of the said prisms, the said liquid crystal element being inserted between the said prisms.

The advantage of this type of configuration is that it balances the two optical paths, therefore there is no residual PMD. The output polarisation direction is either horizontal or perpendicular, and its state is the same as the natural states of the linear birefringent, namely a linear polarisation.

Preferably, this type of device also comprises means of collimation of the said beam at the input and output of the said prisms. This enables separation of the beams.

According to a second advantageous configuration of the device according to the invention, the device has a configuration in reflection and comprises:

a linear birefringent prism,

a half-wave plate located on an optical path of a first refracted order of the said beam at the output from the said prism,

delay means located on an optical path of a second refracted order of the said beam at the output from the said prism,

a mirror,

the said liquid crystal element being located between the said mirror and an assembly comprising the said prism, the said plate and the said delay means.

For example, the prism is a calcite prism. The delay means are used to compensate for the difference in the optical path on the return.

According to a third advantageous configuration of the device according to the invention, the device also comprises:

two linear birefringent prisms mounted top to bottom,

a polarisation separator cube connecting the said prisms,

two half-wave plates arranged on an extraordinary output and an ordinary input of the said prisms, respectively,

the said liquid crystal element being located between the said quarter-wave plate and the said polarisation separator cube.

This more complex third configuration is intended to balance the optical paths. It enables a separation of the input and output, which prevents possible use of a circulator.

According to one advantageous characteristic of the invention, the said system has at least two electrodes also comprising at least one counter electrode, and the said counter electrode comprises at least two electrodes each divided into at least two elementary areas called pixels.

Preferably, the said at least two areas of the said liquid crystal element are each divided into at least two sub-areas in a direction orthogonal to the direction of alignment of the said areas.

Advantageously, the said device comprises means of controlling the addressing voltages of the said sub-areas, enabling complementary reduction of the sensitivity of the said device to polarisation.

According to a first advantageous variant, the said control means maximise addressing voltage differences between two adjacent sub-areas.

Therefore, the number of diffusers completely oriented in a transverse direction will be greater, and the increased orientation of the droplets will increase the efficiency of the method according to the invention for reducing the sensitivity to polarisation.

Preferably, two adjacent sub-areas have alternating addressing voltages. Such alternating voltages provide a means of forcing the existence of transverse fields.

According to a second advantageous variant, the said control means minimise addressing voltage differences between two adjacent sub-areas. The result is to minimise transverse fields between adjacent sub-pixels.

Preferably, the addressing voltages of the said sub-areas are staged approximately uniformly.

The device according to this invention is advantageously used in applications in fields belonging to the group comprising:

attenuation of a light beam,

a at least partial phase shift of a light beam,

spectrum equalisation,

shaping of light beams,

design of variable delay lines,

design of tuneable filters,

selection of spectral bands,

Optical Add Drop Multiplexers (OADM).

Other characteristics and advantages of the invention will become clearer after reading the following description of a preferred embodiment given as a simple illustrative and non-limitative example, and the attached drawings among which:

FIGS. 1a and 1b present the operating principle of a PDLC type liquid crystal cell used in the modulation device according to the invention;

FIG. 2 illustrates the phenomenon for creation of transverse electrical fields in the inter-electrode areas of the cell in FIG. 1;

FIG. 3 shows an example of electrode patterns conform with this invention;

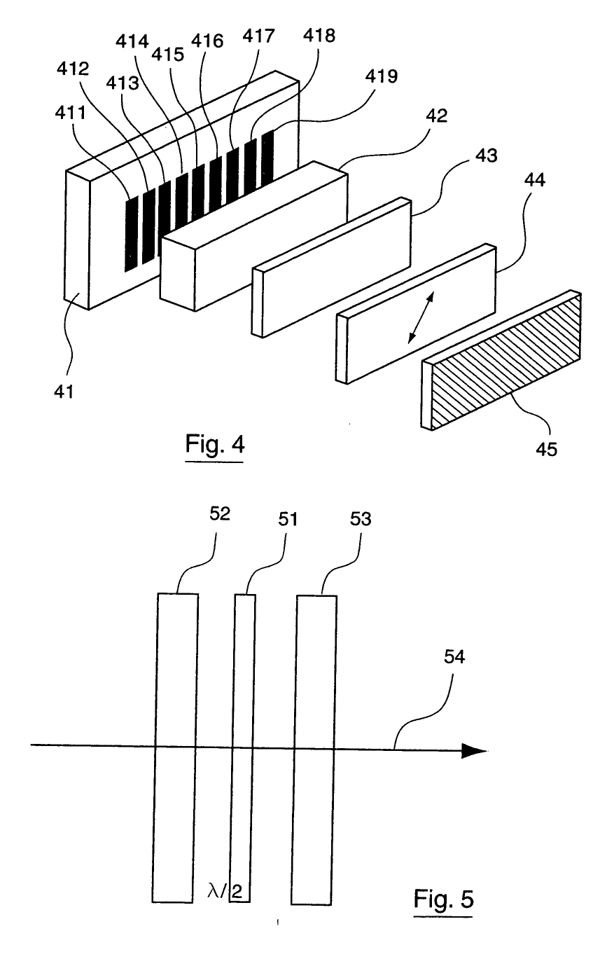

FIG. 4 illustrates a first variant embodiment of the invention in which the sensitivity to polarisation is further reduced by the use of a quarter-wave plate;

FIG. 5 shows a second variant embodiment of the invention using a half-wave plate in a configuration in transmission;

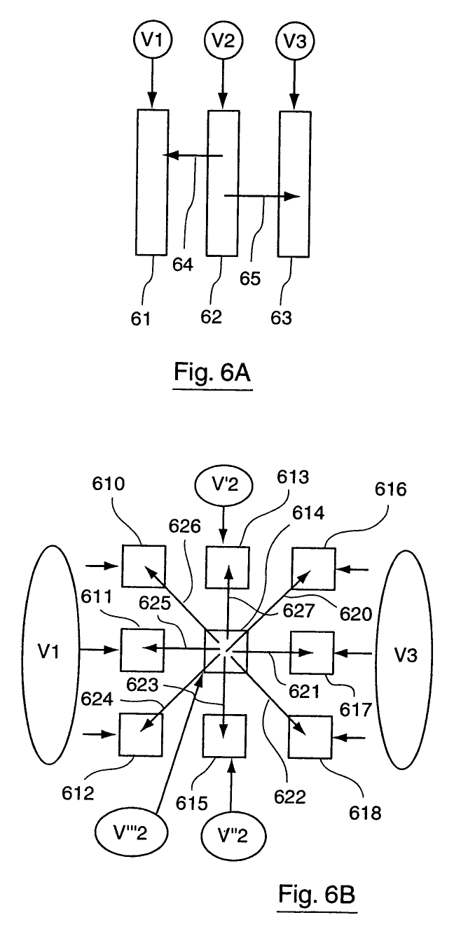

FIGS. 6a and 6b present a third variant embodiment in which the sensitivity to polarisation is further reduced by the use of a two-dimensional structure of modulator pixels in order to reduce the directional isotropy of transverse fields;

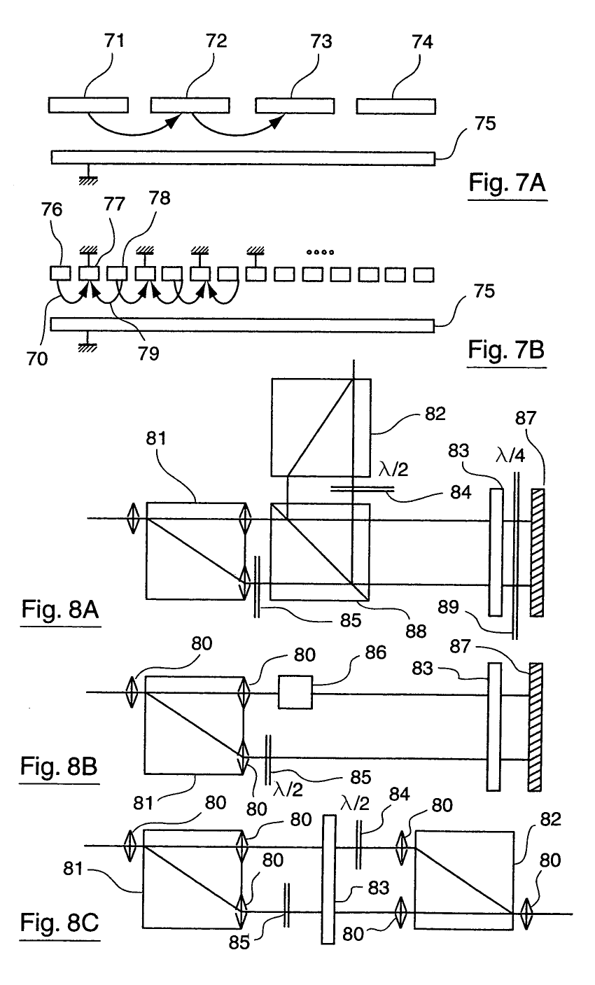

FIGS. 7a and 7b illustrate an improvement to the variant in FIG. 6;

FIGS. 8a to 8c show other variant embodiments of the invention based on the use of linear birefringent prisms.

The general principle of the invention is based on the design of a particular electrode pattern to reduce the harmful alignment of liquid crystal droplets due to the appearance of transverse electrical fields between the modulator electrodes.

FIG. 3 shows an example of an electrode pattern according to the invention.

For example, the modulation device comprises 8 electrodes references 31 to 38, capable of independently addressing 8 areas (or pixels) of the PDLC cell. These electrodes each have a herring bone pattern 30, in which the angle of each of the chevrons is equal to approximately 90°, such that the two preferential alignment directions of the liquid crystal due to the appearance of transverse fields in the inter-pixel areas (for example area 39 between electrodes references 31 to 32) are orthogonal. Thus, the transverse electrical fields compensate and cancel each other.

Any other electrode pattern with zero average, for example a sinusoidal electrode pattern, could also be used.

The incident light beam modulation device can be made more independent of polarisation, apart from using the particular electrode pattern described above, by inserting a quarter-wave plate in a set up of the modulator according to the invention in reflection as shown in FIG. 4.

The modulator 41 comprises 9 electrodes references 411 to 419, for which the pattern is as shown above with relation to FIG. 3, for example. The modulation device according to the invention also includes a PDLC cell 42 and a counter electrode 43. A quarter-wave plate oriented at 45° from the direction of the electrodes 411 to 419 is inserted between the counter electrode 43 of the modulator and a dielectric mirror 45.

The following calculation demonstrates insensitivity of such a modulation device to polarisation.

The modulator may be considered as being a dichroic with an orientation perpendicular to the electrodes, and defined by the following Jones matrix:

$${J}_{d c} = ( \begin{matrix}1 & 0 \\ 0 & {ⅇ}^{- α}\end{matrix} )$$

The Jones matrix for a quarter-wave plate oriented at 45° from this orientation is as follows:

$${J}_{λ / 4} = \frac{1}{\sqrt{2}} ( \begin{matrix}1 & i \\ i & 1\end{matrix} )$$

The composition of the dichroic, the plate and the mirror gives the following result in reflection:

$${J}_{total} = ( \begin{matrix}1 & 0 \\ 0 & {ⅇ}^{- α}\end{matrix} ) \cdot ( \begin{matrix}1 & i \\ i & 1\end{matrix} ) \cdot ( \begin{matrix}1 & i \\ i & 1\end{matrix} ) ( \begin{matrix}1 & 0 \\ 0 & {ⅇ}^{- α}\end{matrix} ) = {ⅈⅇ}^{- α} ( \begin{matrix}0 & 1 \\ 1 & 0\end{matrix} )$$

Therefore, attenuation is done equivalently on the two components of the input polarisation: attenuation is still isotropic but there is no longer any PDL, regardless of the input polarisation. This expression demonstrates that the device is insensitive to an input polarisation for which neither the state nor the orientation can be controlled.

FIG. 5 shows a set up that is equivalent in terms of performance, in which the modulation device is used in transmission.

A function equivalent to that in FIG. 4 can thus be obtained using a half-wave plate 51 inserted between two modulation devices according to the invention, 52 and 53, shown in section in FIG. 5. The direction of propagation of the light beam is illustrated by the arrow reference 54.

We will now present a variant embodiment of the invention with reference to FIGS. 6a and 6b, in which the insensitivity of the modulation device to polarisation is improved due to a particular structure of the areas, or pixels, of the liquid crystal element.

The idea consists of designing a two-dimensional modulation device, in other words using the additional degree of freedom available by the direction orthogonal to the pixellisation direction of the liquid crystal element.

Therefore this variant embodiment uses a two-dimensional modulator for which a single area or pixel is replaced by a set of “sub-pixels” arranged in a direction orthogonal to the direction of alignment of the pixels. Thus, considering areas references 61, 62 and 63 of the PDLC cell aligned horizontally (FIG. 6a), each of these areas (for example the area reference 61) is divided into three sub-areas in the vertical direction (for example sub-areas references 610, 611 and 612—FIG. 6b).

Consequently, when the spatial modulator is used to attenuate a light beam, this attenuation is made by selectively addressing the “sub-pixels” (610, 611, 612) of the structure. By optimising the choice of the addressed pixels and the value of voltages applied to these pixels for a given attenuation level, a less selective distribution of the direction of transverse fields can be obtained, and consequently the dependence of the modulation device on polarisation can be significantly reduced.

When such a variant embodiment is not used, plane fields references 64 and 65 can develop along a horizontal direction, for example in inter-pixel areas between the pixel reference 62 and each of the pixels references 61 and 63.

On the other hand, when each of the pixels 61, 62 and 63 is divided into three sub-pixels references 610 to 618, the addressing voltages V1, V′2, V″2, V′″2 and V3 applied to each of these sub-pixels can be chosen so as to reduce the isotropy of the direction of transverse fields references 620 to 627, for example that develop between the sub-pixel reference 614 and each of its neighbours. Thus, it may be decided to replace the addressing voltage V2 applied to electrode reference 62 by a set of three addressing voltages V′2, V″2 and V′″2 each applied to one of the three sub-pixels reference 613, 614 and 615.

The modulation device according to the invention can be made more independent of polarisation by replacing the counter-electrode of the liquid crystal element by two pixellised electrodes, to reduce inter-electrode voltages. In this case, the voltages to be applied on each pixel of the counter electrode are divided by a factor of two to obtain a longitudinal field equivalent to the solution using a common counter electrode (and therefore an equivalent attenuation level). The transverse fields are correspondingly reduced.

This variant embodiment may or may not be combined with the variant embodiments described with relation to FIG. 6, according to which the areas of the liquid crystal element are divided into sub-areas. It may or may not also be combined with one of the variant embodiments described above with relation to FIGS. 4 and 5 consisting of inserting a quarter-wave or half-wave plate into the set up according to the invention.

We will now present an improvement to the variant embodiment presented with relation to FIG. 6.

As mentioned above, it is possible to obtain an additional degree of freedom by spatially oversampling pixels along the axis of the modulator (pixellisation direction), regardless of the voltages to be supplied to the sub-pixels to obtain a required attenuation level (for example, when the modulation device according to the invention is used for attenuating a light beam). Thus, for the same spectral resolution, a wavelength or spectral band illuminating a pixel will cover several sub-pixels and it will be possible to use these degrees of freedom to strongly reduce transverse fields.

Unlike what is normally expected, a first solution would be to give priority to transverse fields by maximising potential differences between adjacent sub-pixels. Consequently, the number of diffusers (or liquid crystal droplets) oriented completely transversely will be greater than in the case in which there is no oversampling (in other words in the case in which a pixel is not divided into several sub-pixels). As mentioned previously with relation to FIGS. 4 and 5, a phase delay plate (quarter-wave plate or half-wave plate) will have to be used to make the system insensitive to polarisation, but the stronger orientation of the droplets will make the method more efficient.

This first solution is illustrated in FIGS. 7a and 7b. In FIG. 7a, it can be seen that the PDLC cell (not shown) is addressed using a set of electrodes references 71 to 74 and a counter electrode 75. In the variant embodiment in FIG. 7b, each pixel 71 to 74 has been divided into several sub-pixels, only three of which were marked with references 76 to 78 for simplification reasons. As illustrated by the opposing arrows 70 and 79, alternating voltages are applied to these sub-pixels so as to force the existence of transverse fields between the electrodes in inter-pixel areas.

A second and opposing solution consists of using these degrees of freedom by attempting to minimise transverse fields between the sub-pixels.

The device can be made less dependent on polarisation by increasing the number of degrees of freedom (namely sub-pixel addressing voltages) to make it more than the number of constraints (namely the channel levels to be attenuated). Therefore, for example, this solution would consist of regularly staging voltages between sub-pixels.

We will now present other variant embodiments of the invention based on the use of linear birefringent prisms, in relation with FIGS. 8a to 8c. These technical solutions may be used alone in addition to the particular electrode pattern presented in FIG. 3, or in combination with one of the other techniques illustrated in FIGS. 4 to 7.

These solutions are within the more general context of configurations in which the direction of polarisation of the incident light beam is controlled.

In the case in which the incident beam is polarised linearly, it can be oriented along one of the two directions parallel or perpendicular to the direction of the electrodes in the modulation device according to the invention. There is no longer any need to place a quarter-wave plate between the modulator and the mirror, as shown in the configuration in FIG. 4, to make the device according to the invention less sensitive to polarisation. On the other hand, when the polarisation state is arbitrary, the situation is equivalent to the case described above in relation to FIG. 1: the plate further improves the independence of the device to polarisation, and the orientation of the polarisation at the input can then be arbitrary.

Several techniques can be used to control the polarisation at the input.

A first solution consists of using a polarisation diversity device.

Three configurations are then possible. The first configuration in transmission is illustrated in FIG. 8c and for example consists of using two linear birefringent prisms 81 and 82 (for example of the calcite type) mounted top to bottom, between which the PDLC modulator 83 is placed, a half-wave plate 84 is placed at 45° from the orientation of the electrodes, and a half-wave plate 85 is placed at 45° on the output from the first prism 81 on one of the two refracted orders so that it can be reorientated along the orthogonal direction.

An assembly of this type advantageously balances the two optical paths: therefore there is no residual Polarisation Mode Dispersion (PMD). The polarisation direction at the output is either horizontal or perpendicular, and its state is the same as the state of one of the natural states of the linear birefringent 81, namely a linear polarisation. For practical separation reasons, the beams must be collimated using micro lenses 80 at the input and the output of the prism.

Two other configurations in reflection are illustrated in FIGS. 8a and 8b. The configuration in FIG. 8b uses a single calcite prism 81 (with collimation of the beam using micro lenses 80), a half-wave plate 85 following a refracted order output from prism 81 (based on the principle presented above in relation to FIG. 8c) and a delay 86 on the other order to compensate for the optical path difference on the return. The modulator 83 is then arranged in front of a mirror 87.

The configuration in FIG. 8a uses a more complex set up designed to balance the optical paths. Compared with the system presented above in relation with FIG. 4, it also enables separation of the input and output that prevents the potential need to use a circulator. Two linear birefringent prisms 81 and 82 are connected top to bottom through a polarisation separator cube 88. One half-wave plate 84 is placed on their extraordinary output and another half-wave plate 85 is placed on their ordinary input. The modulator 83 is arranged in a configuration identical to that described in FIG. 4, and is combined with a quarter-wave plate 89 and a mirror 87.

At the first passage of the light beam, an arbitrary polarisation is decomposed and is oriented parallel to the inter-pixel field lines. After a double passage of the beam through the quarter-wave plate 89 and the modulator 83, the direction of polarisation of the beam is rotated by 90°, and is therefore routed onto the birefringent output prism 82.

A second solution for controlling the input polarisation in the case of a linear polarisation consists of using optical polarisation maintenance amplifiers. The polarisation direction of the light beam at the input to the device according to the invention is then controlled, and it can be oriented either along the directions orthogonal to the direction of the electrodes or along the perpendicular direction.

Those skilled in the art would find it obvious that the various solutions presented in this document to reduce the sensitivity of the modulation device according to the invention to polarisation can be combined with each other, to optimise improvements to the performances of the modulator, or each solution can be used independently of the others, in combination with an electrode pattern capable of reducing the appearance of transverse fields in inter-electrode areas.

1. Device for spatial modulation of a light beam, comprising a Polymer Dispersed Liquid Crystal (PDLC) element, said element comprising at least two areas that can be addressed independently of each other using a system with at least two electrodes,
characterised in that said electrodes have a predetermined non-linear pattern chosen so as to reduce the sensitivity of said device to polarisation, due to the appearance of at least one transverse electrical field between said electrodes, and in that it also comprises optical means for reducing the sensitivity to polarisation comprising at least one anisotropic phase delay plate.

2. Device according to claim 1, characterised in that said predetermined pattern has a zero average.

3. Device according to claim 1, characterised in that said liquid crystal is of the nano-PDLC type, droplets of said liquid crystal dispersed in said polymer having a diameter of between approximately 10 and 100 nm.

4. Device according to claim 1, characterised in that said predetermined electrode pattern is sinusoidal.

5. Device according to claim 1, characterised in that said predetermined electrode pattern is a saw tooth pattern.

6. Device according to claim 1, characterised in that it has a reflection configuration and in that said phase delay plate is a quarter-wave plate.

7. Device according to claim 6, characterised in that, said system with at least two electrodes also comprising at least one counter electrode, said quarter-wave plate is oriented at approximately 45° from the direction of said electrodes, and is inserted between said counter electrode and a mirror.

8. Device according to claim 1, characterised in that it has a configuration in transmission and in that said phase delay plate is a half-wave plate.

9. Device according to claim 8, characterised in that said half-wave plate is inserted between two adjacent liquid crystal elements.

10. Device according to any one of claims 1 to 5, 8 and 9 claim 1, characterised in that it has a configuration in transmission and comprises:
two linear birefringent prisms, mounted top to bottom,
a first half-wave plate oriented at approximately 45° from the direction of said electrodes,
a second half-wave plate located on an optical path of a refracted order of said beam at the output of one of said prisms,
said liquid crystal element being inserted between said prisms.

11. Device according to claim 10, characterised in that it also comprises means of collimation of said beam at the input and output of said prisms.

12. Device according to any one of claims 1 to 7 claim 1, characterised in that it has a configuration in reflection and comprises:
a linear birefringent prism,
a half-wave plate located on an optical path of a first refracted order of said beam at the output from said prism,
delay means located on an optical path of a second refracted order of said beam at the output from said prism,
a mirror,
said liquid crystal element being located between said mirror and an assembly comprising said prism, said plate and said delay means.

13. Device according to claim 7, characterised in that it also comprises:
two linear birefringent prisms mounted top to bottom,
a polarisation separator cube connecting said prisms,
two half-wave plates arranged on an extraordinary output and an ordinary input of said prisms, respectively,
said liquid crystal element being located between said quarter-wave plate and said polarisation separator cube.

14. Device according to claim 1, characterised in that, said system with at least two electrodes also comprising at least one counter electrode, said counter electrode comprises at least two electrodes each divided into at least two elementary areas called pixels.

15. Device according to claim 1, characterised in that said at least two areas of said liquid crystal element are each divided into at least two sub-areas in a direction orthogonal to the direction of alignment of said areas.

16. Device according to claim 1, characterised in that it comprises means of controlling the addressing voltages of said sub-areas, enabling complementary reduction of the sensitivity of said device to polarisation.

17. Device according to claim 16, characterised in that said control means maximise addressing voltage differences between two adjacent sub-areas.

18. Device according to claim 17, characterised in that two adjacent sub-areas have alternating addressing voltages.

19. Device according to claim 16, characterised in that said control means minimise addressing voltage differences between two adjacent sub-areas.

20. Device according to claim 19, characterised in that the addressing voltages of said sub-areas are staged approximately uniformly.

21. Applications of the device according to claim 1 in fields belonging to the group comprising:
attenuation of a light beam,
a at least partial phase shift of a light beam,
spectrum equalisation,
shaping of light beams,
design of variable delay lines,
design of tuneable filters,
selection of spectral bands,
Optical Add Drop Multiplexers (OADM).
